(19) United States
(12) Patent Application Publication
(10) Pub. No.: US 2018/0267296 A1
(43) Pub. Date: Sep. 20, 2018

(54) ELECTRICALLY CONDUCTIVE POLYMER FILM

(71) Applicant: Delphi Technologies, Inc., Troy, MI (US)

(72) Inventors: Zachary J. Richmond, Warren, OH (US); Evangelia Rubino, Warren, OH (US)

(21) Appl. No.: 15/463,033

(22) Filed: Mar. 20, 2017

(51) Int. Cl. G02B 27/00; B60R 1/06; G02B 1/14; B60J 1/00; H05B 3/84; H05B 3/14

(52) U.S. Cl. CPC G02B 27/0006; B60R 1/0602; G02B 1/14; H01B 1/22; H05B 3/845; H05B 3/84; H05B 3/146; B60J 1/002

(57) ABSTRACT

An electrically conductive polymer film is presented. The electrically conductive polymer film includes a polymeric base material, a plurality of electrically conductive nanoparticles randomly oriented within the polymeric base material, and a pair of electrodes electrically interconnected with the plurality of electrically conductive nanoparticles. The electrodes are configured to be connected to an electrical power source. The polymeric base material may e.g. be polyethylene, polypropylene, polyvinyl chloride, polycarbonate, acrylic, polyester, and/or polyamide. The plurality of electrically conductive nanoparticles may be metallic nanowires, metal-plated nanofibers, carbon nanotubes, graphene nanoparticles, and/or graphene oxide nanoparticles. The plurality of electrically conductive nanoparticles may also or alternatively include an inherently conductive polymer such as polylanine, 3,4-ethylenedioxythiophene, 3,4-ethylenedioxythiophene polystyrene sulfonate, and/or 4,4-cyclopentadithiophene. The plurality of electrically conductive nanoparticles may be substantially uniformly distributed throughout the polymeric base material.

### TECHNICAL FIELD OF THE INVENTION

The invention generally relates to an electrically conductive polymer film, and more particularly relates to an electrically conductive polymer film suitable for use in defroster and/or defogger applications.

### BACKGROUND OF THE INVENTION

Warm air from a vehicle's heating, ventilation, and air conditioning (HVAC) system is typically used to remove fogging, frost, snow, and ice, from a vehicle's windshield and front side windows, hereinafter generically referred to as defrosting. However, routing additional ductwork to carry heated air from the HVAC system to other window surfaces, such as the vehicle's rear window or outside mirrors, has been found to the uneconomical and/or ineffective. Therefore, secondary defrosting systems using resistive heating to defrost rear windows and mirrors and typically include resistive wires embedded within the glass or resistive circuits printed on an interior surface of the glass as shown in FIG. 1. Defrosting using these methods is non-uniform, as the area around the resistive circuits will heat up first. Additionally, production of windows and mirrors with embedded wires or printed circuits require manufacturing steps additional steps. The printed circuits are also easily damaged by abrasion or cracking.

Therefore, an improved apparatus for secondary defrosting of vehicle windows and mirrors remains desired.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

In accordance with an embodiment of the invention, an electrically conductive polymer film is provided. The electrically conductive polymer film includes a polymeric base material, a plurality of electrically conductive nanoparticles randomly oriented within the polymeric base material, and a pair of electrodes electrically interconnected with the plurality of electrically conductive nanoparticles. These electrodes are configured to be connected to an electrical power source.

The polymeric base material may be polyethylene, polypropylene, polyvinyl chloride, polycarbonate, acrylic, polyester, or polyamide material. The plurality of electrically conductive nanoparticles may be metallic nanowires, metal-plated nanofibers, carbon nanotubes, graphene nanoparticles, and/or graphene oxide nanoparticles. The plurality of electrically conductive nanoparticles may comprise 0.01% to 0.1% by weight of the electrically conductive polymer film. The plurality of electrically conductive nanoparticles may also or alternatively include an inherently conductive polymer. The inherently conductive polymer may be one or more of the following: polylanine, 3,4-ethylenedioxythiophene, 3,4-ethylenedioxythiophene polystyrene sulfonate, and/or 4,4-cyclopentadithiophene. The plurality of electrically conductive nanoparticles may be substantially uniformly distributed throughout the polymeric base material.

In accordance with another embodiment of the invention, a window assembly having defrosting capabilities configured to be disposed on a motor vehicle. The window assembly includes a first transparent substrate and the electrically conductive polymer film described above. In this embodiment, the polymeric base material is transparent. The electrically conductive polymer film is applied to a major surface of the first transparent substrate. The window assembly may further include a first adhesive layer that is located intermediate the electrically conductive polymer film and the first transparent substrate. The window assembly may also include a transparent protective layer that is applied to a surface of the electrically conductive polymer film and a second adhesive layer intermediate the electrically conductive polymer film and the transparent protective layer. The window assembly may yet further include a second transparent substrate. In this case, the electrically conductive polymer film is intermediate the first transparent substrate and the second transparent substrate.

In accordance with yet another embodiment of the invention, a mirror assembly having defrosting capabilities configured to be disposed on a motor vehicle. The mirror assembly includes a mirror formed of a substrate with a transparent surface and a silvered surface opposite the transparent surface and the electrically conductive polymer film described above applied to the transparent surface or the silvered surface of the substrate. The mirror assembly may include a first adhesive layer intermediate the electrically conductive polymer film and the substrate. The polymeric base material may be transparent. In this instance, the electrically conductive polymer film is preferably applied to the transparent surface of the substrate. The mirror assembly may further include a transparent protective layer applied to a surface of the electrically conductive polymer film and a second adhesive layer intermediate the electrically conductive polymer film and the transparent protective layer.

### BRIEF DESCRIPTION OF THE SEVERAL VIEWS OF THE DRAWING

The present invention will now be described, by way of example with reference to the accompanying drawings, in which:

FIG. 1 is a side view of a vehicle rear window glass with a defroster formed of a printed circuit in accordance with the prior art;

FIG. 2 is a perspective view of a vehicle with a rear window glass with a defroster formed of an electrically conductive polymer film in accordance with several embodiments of the invention;

FIG. 3 is a cross section view of the rear window glass with a defroster formed of an electrically conductive polymer film of FIG. 1 in accordance with a first embodiment of the invention;

FIG. 4 is a cross section view of the rear window glass with a defroster formed of an electrically conductive polymer film of FIG. 1 in accordance with a second embodiment of the invention;

FIG. 5 is a side view of a rear view mirror with a defroster formed of an electrically conductive polymer film in accordance with several embodiments of the invention;

FIG. 6 is a cross section view of the rear view mirror with a defroster formed of an electrically conductive polymer film of FIG. 5 in accordance with a third embodiment of the invention; and

FIG. 7 is a cross section view of the rear view mirror with a defroster formed of an electrically conductive polymer film of FIG. 5 in accordance with a fourth embodiment of the invention.

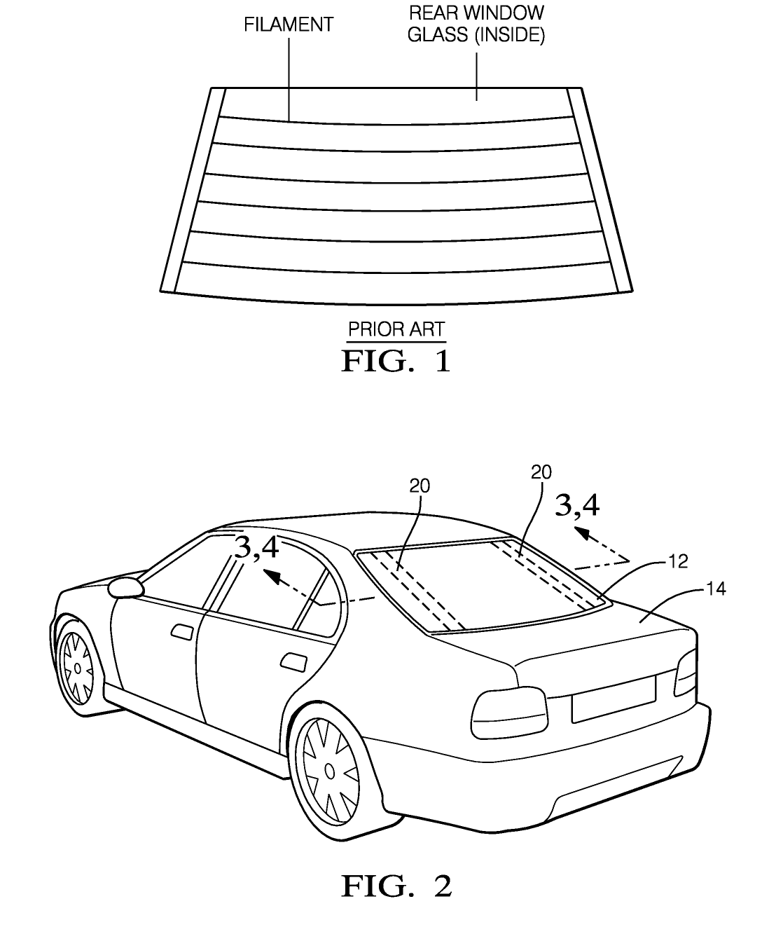

### DETAILED DESCRIPTION OF THE INVENTION

An electrically conductive polymer film that can be applied to windows, mirrors, sensors, lights, and other devices to provide defrosting capabilities is presented herein. The film is formed of a polymeric base material and includes electrically conductive nanoparticles that are randomly oriented in the polymeric material and interconnected to form an electrical network. Without subscribing to any particular theory of operation, when an electrical current is applied to the film through a pair of conductive electrodes , the electrical power dissipated within the film causes the film to heat, thereby defrosting the device to which the film is applied.

Low loadings of conductive nanoparticles within a transparent polymeric material in the range of 0.01% to 0.1% by weight have been shown to create an electrically conductive polymer film with transparent properties. Suitable transparent polymeric materials include polyethylene, polypropylene, polyvinyl chloride, polycarbonate, acrylic, polyester, or polyamide material. The conductive nanoparticles are preferably formed of metal or carbon. Most notably these would include but are not limited to silver nanowires, carbon nanotubes, graphene, graphene oxide, and other non-metallic electrically conductive nanoparticles. These transparent electrically conductive polymer films are particularly well suited for defrosting applications of windows, mirrors, sensors, lights, and displays. Other electrically conductive polymer films may include other polymeric materials such as polyester and polyamide and may contain a higher loading of conductive nanoparticles exceeding 0.1% by weight rendering the electrically conductive polymer films non-transparent, but may be used in thither application where transparency is not required, such as heating of switches, steering wheels, etc.

The conductive nanoparticles have at least one dimension that falls within the nanoscale which typically ranges from 1 to 100 nanometers. It should also be understood that another dimension of the nanoparticles may be outside of the nanoscale. For example, a nanoparticle may be a carbon nanotube having a diameter that is within the nanoscale and a length that is longer than the nanoscale.

Inherently conductive polymers, e.g. polylanine, 3,4-ethylenedioxythiophene, 3,4-ethylenedioxythiophene polystyrene sulfonate, and 4,4-cyclopentadithiophene, may also be used as conductive nanoparticles to create the electrically conductive polymer film. Inherently conductive polymers (including conjugated and radical polymers) have limited processability. Including these conductive polymers in a processable polymeric matrix would allow the production of an electrically conductive polymer film as described above. Electroactive polymers that retain base polymer properties and induce conductivity through nanometals bonded into the polymer chain could also be used to create electrically conductive polymer film.

Electrically conductive polymer films are produced by compounding or mixing the conductive particles into the polymeric material or solution. The compounded material would then be formed into a film in a cast extrusion, extrusion, calendaring, extrusion coating, or solution film casting process. The electrically conductive polymer film may be combined with multiple layers to produce desired design properties. For example, a polymer with abrasion resistance may be added to the film to provide protection to the conductive layer.

Resistive heating through the conductive film would allow the electrically conductive polymer film to defrost specific areas. The electrical current applied to the electrically conductive polymer film may be regulated to the specific resistance and plastic to insure no overheating of the plastic (maintain temperature of the film below melting/softening temperatures of polymeric base material).

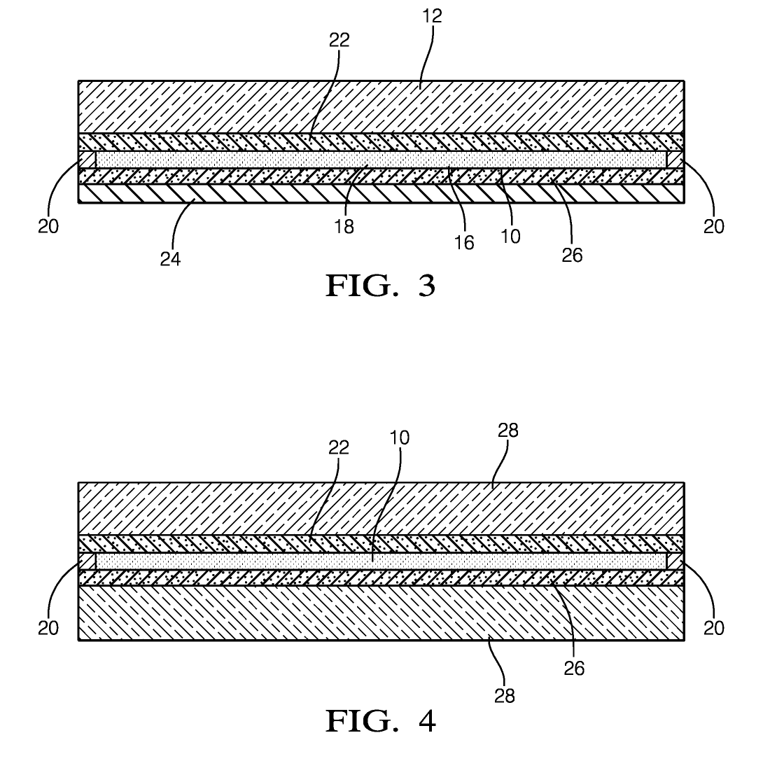

FIG. 2 illustrates a non-limiting example of a transparent electrically conductive polymer film 10 applied to a major surface of a rear window 12 of a motor vehicle 14 to provide defrosting capabilities. The rear window 12 is formed of a substantially transparent silicon-based glass but alternatively may be formed of a transparent polymer or glass/polymer composite. As shown in FIG. 3, the electrically conductive polymer film 10 includes a polymeric base material 16, a plurality of electrically conductive nanoparticles 18 randomly oriented within the polymeric base material 16, and a pair of electrodes 20 electrically interconnected with the plurality of electrically conductive nanoparticles 18. The electrodes 20 are configured to be connected to the vehicle's electrical system.

The polymeric base material 16 may be a transparent polyethylene, polypropylene, polycarbonate, acrylic, or polyvinyl chloride material. The plurality of electrically conductive nanoparticles 18 may be metallic nanowires, metal-plated nanofibers, carbon nanotubes, graphene nanoparticles, and/or graphene oxide nanoparticles. The plurality of electrically conductive nanoparticles 18 comprise 0.01% to 0.1% by weight of the electrically conductive polymer film 10. The plurality of electrically conductive nanoparticles 18 may also or alternatively include an inherently conductive polymer. The inherently conductive polymer may be one or more of the following: polylanine, 3,4-ethylenedioxythiophene, 3,4-ethylenedioxythiophene polystyrene sulfonate, and/or 4,4-cyclopentadithiophene. The plurality of electrically conductive nanoparticles 18 are substantially uniformly distributed throughout the polymeric base material 16. The electrically conductive polymer film 10 is applied to a major surface of the rear window 12.

As further illustrated in FIG. 3, the rear window assembly 12 may further include a first adhesive layer 22 that is located intermediate the electrically conductive polymer film 10 and the rear window 12. The window assembly may also include a transparent protective layer 24 that is applied to a surface of the electrically conductive polymer film 10 and a second adhesive layer 26 intermediate the electrically conductive polymer film 10 and the transparent protective layer 24.

As illustrated in FIG. 4, the rear window assembly 12 may have a laminated construction with the electrically conductive polymer film 10 sandwiched between two glass sheets 28 with a first and second adhesive layer 22, 26 between the electrically conductive polymer film 10 and each of the two glass sheets 28.

While the preceding illustrated examples show a rear window 12, the film may be applied to other windows, such as side door windows to provide defrosting capabilities.

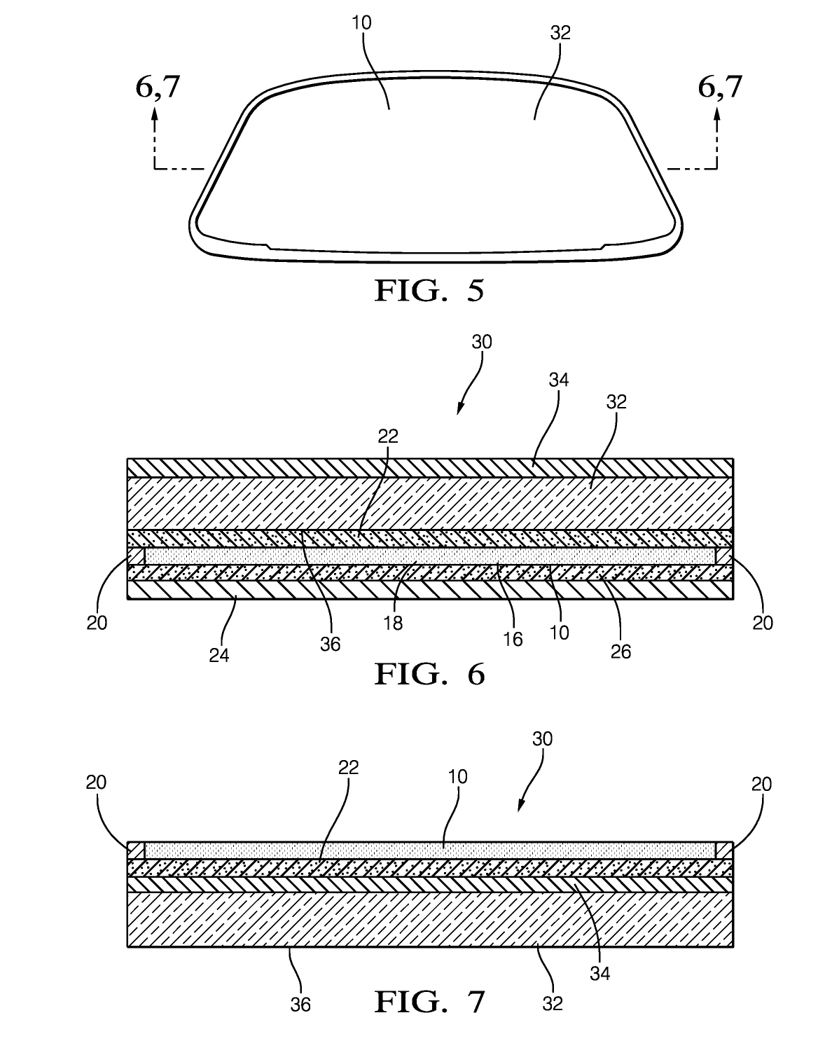

FIG. 5 illustrates a non-limiting example of an electrically conductive polymer film 10 applied to a major surface of a rear view mirror 30 of a motor vehicle to provide defrosting capabilities.

As shown in FIG. 6, the rear view mirror 30 is formed of a substantially transparent silicon-based glass substrate 32 having a silvering material 34 applied to one of the major surfaces to provide reflectivity. The electrically conductive polymer film 10 may be applied to a transparent major surface 36 that is opposite the silvered surface 34. In this example, the electrically conductive polymer film 10 is formed of a transparent base material and the electrically conductive nanoparticles 18 comprise 0.01% to 0.1% by weight of the electrically conductive polymer film 10. The rear view mirror assembly 30 may include a first adhesive layer 22 intermediate the electrically conductive polymer film 10 and the rear view mirror 30. In this instance, the electrically conductive polymer film 10 is preferably applied to the transparent surface of the mirror 30. The rear view mirror assembly 30 may further include a transparent protective layer 24 applied to a surface of the electrically conductive polymer film 10 and a second adhesive layer 26 intermediate the electrically conductive polymer film 10 and the transparent protective layer 24.

As illustrated in FIG. 7, the electrically conductive polymer film 10 may be alternatively applied to the silvered surface 34 of the mirror 30. In this example, the electrically conductive polymer film 10 is formed of a polymeric base material 16 that is not necessarily transparent and the electrically conductive nanoparticles 18 may exceed 0.1% by weight of the electrically conductive polymer film 10. The rear view mirror assembly 30 may also include a first adhesive layer 22 intermediate the electrically conductive polymer film 10 and the silvered surface 34.

Accordingly, an electrically conductive polymer film 10 that may be applied to deliver defrosting capabilities is provided. The electrically conductive polymer film 10 provides reducing the complexity of manufacturing steps for adding. Applying a conductive film would be lower cost and is more efficient then embedding wires in glass or printing ceramic traces on the glass surface. Protection against abrasion of the defroster would no longer be an issue as a small scratch would not affect the performance as the whole material is conductive, not just circuit traces. A protective polymer layer can also be used to protect the conductive film from abrasion. The film could potentially be applied between two panels of glass to further provide protection. The electrically conductive polymer film 10 will also heat at a uniform rate across the windshield. Finally, since the electrically conductive polymer film 10 may be transparent with no wires or printed circuits, thereby enhancing the vision through the glass.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items. Additionally, directional terms such as upper, lower, etc. do not denote any particular orientation, but rather the terms upper, lower, etc. are used to distinguish one element from another and locational establish a relationship between the various elements.

We claim:

1. A electrically conductive polymer film, comprising:
a polymeric base material;
a plurality of electrically conductive nanoparticles randomly oriented within the polymeric base material; and
a first and second electrode electrically interconnected with the plurality of electrically conductive nanoparticles and configured to be connected to an electrical power source.

2. The electrically conductive polymer film according to claim 1, wherein the polymeric base material is transparent.

3. A window assembly having defrosting capabilities configured to be disposed on a motor vehicle, comprising:
a first transparent substrate; and
the electrically conductive polymer film according to claim 2 applied to a major surface of the first transparent substrate.

4. The window assembly according to claim 3, further comprising a first adhesive layer intermediate the electrically conductive polymer film and the first transparent substrate.

5. The window assembly according to claim 4, further comprising a transparent protective layer applied to a surface of the electrically conductive polymer film and a second adhesive layer intermediate the electrically conductive polymer film and the transparent protective layer.

6. The window assembly according to claim 3, further comprising a second transparent substrate and wherein the electrically conductive polymer film is intermediate the first transparent substrate and the second transparent substrate.

7. The electrically conductive polymer film according to claim 2, wherein the plurality of electrically conductive nanoparticles comprise 0.01% to 0.1% by weight of the electrically conductive polymer film.

8. The electrically conductive polymer film according to claim 1, wherein the polymeric base material is selected from the group consisting of: polyethylene, polypropylene, polyvinyl chloride, polycarbonate, acrylic, polyester, and polyamide.

9. The electrically conductive polymer film according to claim 1, wherein the plurality of electrically conductive nanoparticles are selected from the group consisting of:
metallic nanowires, metal-plated nanofibers, carbon nanotubes, graphene nanoparticles, and graphene oxide nanoparticles.

10. The electrically conductive polymer film according to claim 1, wherein the plurality of electrically conductive nanoparticles comprise an inherently conductive polymer.

11. The electrically conductive polymer film according to claim 10, wherein the inherently conductive polymer is selected from the group consisting of: polylanine, 3,4-ethylenedioxythiophene, 3,4-ethylenedioxythiophene polystyrene sulfonate, and 4,4-cyclopentadithiophene.

12. The electrically conductive polymer film according to claim 1, wherein the plurality of electrically conductive nanoparticles are substantially uniformly distributed throughout the polymeric base material.

13. A mirror assembly having defrosting capabilities configured to be disposed on a motor vehicle, comprising
a mirror formed of a substrate with a transparent surface and a silvered surface opposite the transparent surface; and
the electrically conductive polymer film according to claim 1 applied to the transparent surface or the silvered surface of the substrate.

14. The mirror assembly according to claim 13, further comprising a first adhesive layer intermediate the electrically conductive polymer film and the substrate.

15. The mirror assembly according to claim 14, wherein the polymeric base material is transparent and wherein the electrically conductive polymer film is applied to the transparent surface of the substrate.

16. The mirror assembly according to claim 15, further comprising a transparent protective layer applied to a surface of the electrically conductive polymer film and a second adhesive layer intermediate the electrically conductive polymer film and the transparent protective layer.
